(19) United States
(12) Patent Application Publication
(10) Pub. No.: US 2018/0241674 A1
(43) Pub. Date: Aug. 23, 2018

(54) SELECTIVELY PROCESSING NETWORK PACKETS

(71) Applicant: Hewlett Packard Enterprise Development LP, Houston, TX (US)

(72) Inventors: Sankaran Balaji, Bangalore Karnataka (IN); Tathagata Nandy, Bangalore Karnataka (IN); Nilay Tripathi, Bangalore Karnataka (IN); Saheli Ganguly, Bangalore Karnataka (IN)

(21) Appl. No.: 15/497,282

(22) Filed: Apr. 26, 2017

(30) Foreign Application Priority Data
Feb. 23, 2017 (IN) 201741006559

(51) Int. Cl. H04L 12/801; H04L 12/721; H04L 12/26; H04L 29/08; H04L 12/18

(52) U.S. Cl. CPC H04L 47/12; H04L 45/26; H04L 12/18; H04L 67/2842; H04L 43/028

(57) ABSTRACT

Examples relate to selectively processing network packets. In one example, a computing device may receive, by the networking device, a network packet from a user device operating on the network; determine that the network packet is a search packet, the search packet specifying a particular service associated with a server device; provide a network controller with a query for the particular service; receive, from the network controller, an indication that the particular service is not provided by server devices operating on the network; and determine, based on the receipt of the indication, not to process the search packet.

### BACKGROUND

Computer networks may often experience a high volume of network traffic from across a variety of network devices and from a variety of user devices. High traffic volume may lead to bottlenecks that can cause a degradation in network speed and/or user experience. Various techniques are used to prevent bottlenecks and losses in network throughput or speed, such as the use of different priorities for different types of network traffic, load balancing, and adding network resources to handle additional network traffic.

### BRIEF DESCRIPTION OF THE DRAWINGS

The following detailed description references the drawings, wherein:

FIG. 1 is a block diagram of an example networking device for selectively processing network packets.

FIG. 2 is an example data flow depicting the selective processing of network packets.

FIG. 3 is a flowchart of an example method for selectively processing network packets.

FIG. 4 is a flowchart of an example method for the selective processing of network packets.

### DETAILED DESCRIPTION

A computer network may experience a high volume of network traffic associated with multicast requests for various network services. A computer network may include a variety of server devices that offer network services that are accessible to other devices connected to the network. Devices that communicate with the network may send out multicast requests looking for particular services. For example, an enterprise network may include several multimedia servers that provide access to a variety of media content, and/or communications servers that provide access to messaging services; user devices may be running applications that automatically send out multicast requests to search for the services available on the network. The multicast requests that are sent by the user devices are handled by network devices operating on the network.

Rather than processing every network packet that includes a multicast request, network devices may selectively process these network packets based on whether or not the services being requested are available on the network. Availability may be determined by querying a cache that stores data specifying available network services and the server devices that support those network services. In situations where a service is requested via a multicast request, and that service is not included in the cache, the network device that received the request may cancel any network flow associated with the request. In situations where the requested service is available, the network device that received the request may process the request and process the network flow associated with the request, e.g., in a manner designed to allow the requesting device access to the server device that offers the requested service.

By way of example, a network controller may store data that specifies network services that are i) offered by various server devices operating on an enterprise network and ii) discoverable by user devices via multicast requests, such as Simple Service Discovery Protocol (SSDP) packets. A user device may send an SSDP packet to a network router, and the SSDP packet may specify a particular network service. The network router may identify the SSDP packet, e.g., by destination IP address, and perform packet inspection to identify the type of SSDP packet. After determining that the SSDP packet is a request for the particular network service, the network router may send a query to the network controller for the particular service. The network controller determines, e.g., using the stored data regarding network services, whether the particular service is offered by one of the server devices operating on the network. As noted above, in situations where the requested service is available, the network controller may provide a response to the network router indicating the service's availability. In situations where the requested service is not available, the response provided to the network router may indicate the service's unavailability, causing the network router to cancel further processing of the SSDP packet. Further details regarding the selective processing of network packets are described in the paragraphs that follow.

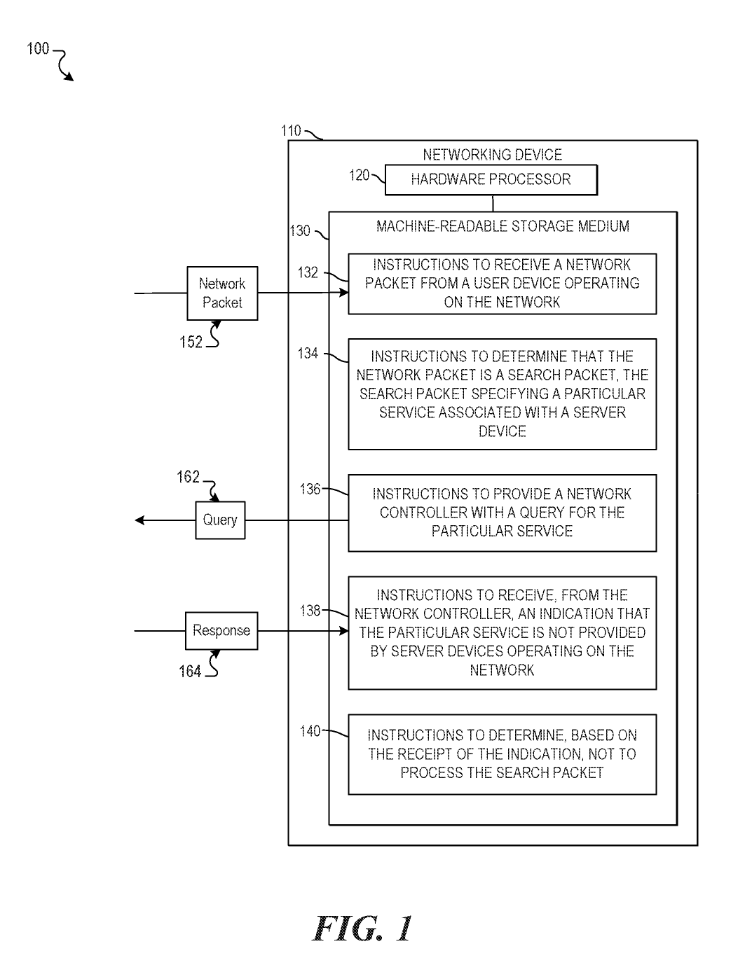

Referring now to the drawings, FIG. 1 is a block diagram 100 of an example networking device 110 for selectively processing network packets. Networking device 110 may be, for example, a network router, network switch, network controller, server computer, or any other similar electronic device—virtual or physical—capable of processing network packets. In the example implementation of FIG. 1, the networking device 110 includes a hardware processor, 120, and machine-readable storage medium, 130.

Hardware processor 120 may be one or more central processing units (CPUs), semiconductor-based microprocessors, and/or other hardware devices suitable for retrieval and execution of instructions stored in machine-readable storage medium 130. Hardware processor 120 may fetch, decode, and execute instructions, such as 132-140, to control processes for selectively processing network packets. As an alternative or in addition to retrieving and executing instructions, hardware processor 120 may include one or more electronic circuits that include electronic components for performing the functionality of one or more instructions, e.g., a Field Programmable Gate Array (FPGA) or Application Specific Integrated Circuit (ASIC).

A machine-readable storage medium, such as 130, may be any electronic, magnetic, optical, or other physical storage device that contains or stores executable instructions. Thus, machine-readable storage medium 130 may be, for example, Random Access Memory (RAM), non-volatile RAM (NVRAM), an Electrically Erasable Programmable Read-Only Memory (EEPROM), a storage device, an optical disc, and the like. In some implementations, storage medium 130 may be a non-transitory storage medium, where the term “non-transitory” does not encompass transitory propagating signals. As described in detail below, machine-readable storage medium 130 may be encoded with executable instructions 132-140, for selectively processing network packets.

As shown in FIG. 1, the hardware processor 120 executes instructions 132 to receive a network packet 152 from a user device operating on a network. For example, the networking device 110 may be a network router that is in communication with a variety of networking devices, and the user device may be a mobile phone that is in communication with the network router. In some implementations, the network packet 152 is a multicast packet, such as a SSDP packet. A multicast packet is a network packet that is designed to be sent to multiple devices, e.g., in search of a particular network service.

The hardware processor 120 executes instructions 134 to determine that the network packet 152 is a search packet, the search packet specifying a particular service associated with a server device. For example, the networking device may determine that the network packet 152 is associated with a multicast message, or multicast protocol, based on a network address specified by the network packet 152. E.g., certain IP addresses may be previously associated with multicast services, and an SSDP packet may be identified by its destination address matching one of these IP addresses. The networking device 110 may also perform packet inspection, e.g., in response to determining that the network packet 152 is associated with a multicast message/protocol. In this situation, the determination that the network packet 152 is a search packet may be made based on the packet inspection, e.g., an SSDP packet may specify its type, such as notify type or search type, which may be discovered by inspecting the SSDP packet.

The hardware processor 120 executes instructions 136 to provide a network controller with a query 162 for the particular service. One example service is a display service provided by SSDP compatible display devices, such as a television or monitor that supports streaming from a user device. In some implementations, the network controller may store data includes the network services provided by the network to which the network controller and networking device 110 are connected. For example, various server devices may send data indicating network services that are provided by the server devices, e.g., a SSDP enabled television may notify a network router that it provides a display service that allows other network devices to display data on the SSDP enabled television. The network router may notify the network controller, which may then store an IP address and data identifying the display service in a local cache. The query 162 provided by the networking device 110 may be used by the network controller to determine whether the particular service requested by the user device is available on the network.

The hardware processor 120 executes instructions 138 to receive, from the network controller, an indication that the particular service is not provided by server devices operating on the network. In the example diagram 100, the network controller provides the indication in a response 164. For example, after determining that the particular service specified by the query 162 is not included in a list of network services available on the network, the network controller sends a response 164 to the networking device 110 to indicate that the requested service is not available.

The hardware processor 120 executes instructions 140 to determine, based on the receipt of the indication, not to process the search packet. In the example situation above, the response 164 indicates that the particular service requested in the network packet 152 is not available on the network. Based on the receipt of that indication, further processing of the network packet 152 that included the request may be halted. For example, rather than continuing to process a SSDP request by broadcasting it to all devices operating on the same network in search of the particular service—creating multiple network flows to do so—the networking device 110 may cancel the related network flows, potentially reducing consumption of network resources. In some implementations, the networking device 110 may notify the user device that the requested service is not available.

In some implementations, the networking device 110 receives a notify packet from a server device operating on the same network. For example, a multicast compatible audio device may be considered a server device, and the audio device may send a multicast notify packet designed to notify the network of its availability. The network controller may receive this notify packet, e.g., directly or through a networking device, and add the audio service offered by the audio device to a cache of network services. Additional data may also be stored by the network controller, such as an IP address for the sender of the notify packet.

In some implementations, the network controller may provide a response 164 that indicates that the particular service is available on the network. For example, in a situation where the network controller has previously received a notify packet for the particular service—and recorded the service in data storage—the network controller may notify the networking device that the particular service is available. In some implementations, additional data may be included in the response, such as an IP address for the server device that provides the particular service.

In situations where the networking device 110 is notified that the particular service is available, the networking device 110 may determine to process the search packet. Processing the search packet may include, for example, identifying routing data—such as an IP address—in the response 164 and routing the search packet to the corresponding server device. In the example above, a network router may route an SSDP search request to an audio device that provides an audio service that the user device 150 requested with its multicast request.

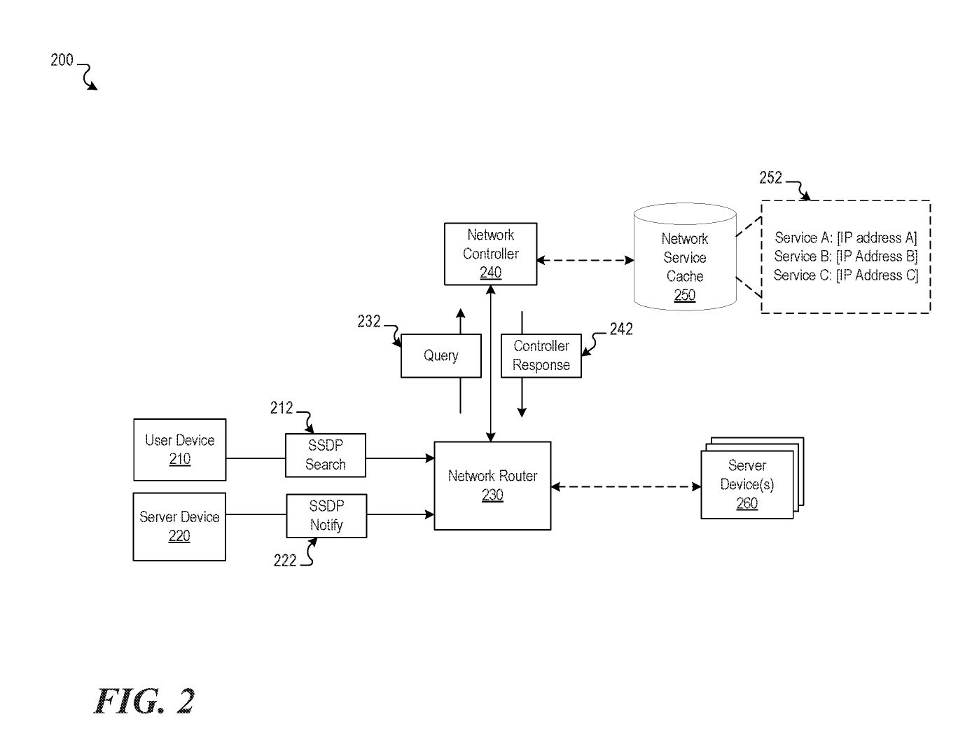

FIG. 2 is an example data flow 200 depicting the selective processing of network packets, and SSDP packets in particular. The example data flow 200 depicts several devices operating on the same network, including a user device 210, a server device 220, a network router 230, a network controller 240, a network service cache 250, and a group of server devices 260. The network router 230 may be any hardware device capable of handling network communications, such as a device similar to the networking device 110 of FIG. 1. The user device 210 and server device 220 are also computing devices capable of network communications, such as personal computers, server computers, or mobile computers. A server device 220 or server devices 260, may also be multicast compatible devices that provide network services, including Internet of Things (IoT) devices, such as a multicast compatible speaker, multicast compatible television, multicast compatible thermostat, multicast compatible appliances, etc. The network controller 240 may be any computing device capable of managing carious aspects of a network, e.g., configuring network switches, routers, and other devices connected to a particular network. While the network service cache 250 is depicted as a data storage device that is separate from the network controller 240, it may be included in the network controller 240.

During operation, the network router 230 receives SSDP packets from a user device 210 and a server device 220. In the example data flow 200, after receiving the SSDP search packet 212 from the user device, the network router 230 sends a query 232 to the network controller. As noted above, the network router may determine that the SSDP search packet 212 is an SSDP packet based on its destination address, and it may determine that it is a search packet by inspecting the packet to find data identifying its type. The query 232 provided to the network controller 240 may include the SSDP search packet 212 and/or data specifying the network service specified by the SSDP search packet 212.

In response to receiving the query 232, the network controller 240 determines whether the requested service is provided by any of the server devices 220 or 260 operating on the network. This determination is made, for example, by consulting the network service cache 250, which includes the services that are provided by server devices operating on the network. For example, a list of services 252 specifies three services, A, B, and C, and corresponding IP addresses of the server devices that offer those services. Whether the requested services is included in the network service cache 250 or not, the network controller 240 sends a response 242 to the network router 230.

In situations where the controller response 242 indicates that the requested service is not included in the network service cache 250, the network router 230 may halt any further processing related to the SSDP search packet 212. For example, rather than forwarding the SSDP search packet to all server devices operating on the network in search of the particular network service, the network router 230 may notify the user device 210 that the requested service is not available.

In situations where the controller response 242 indicates that the requested service is included in the network service cache 250, the network router 230 may process the SSDP search packet 212. This may include, for example, routing the SSDP search packet 212 to the server device that provides the requested service. The network router 230 may determine which server device provides the requested service using data included in the controller response 242, such as an IP address of the server device.

The example data flow 200 also depicts a server device 220 providing a SSDP notify packet 222 to the network router 230. Server devices may send SSDP notify packets to announce the availability of network services provided by the network devices. For example, after connecting to Wi-Fi network, a multicast compatible home appliance may send an SSDP notify packet to the network router to which it is connected. The network router 230 may then forward the SSDP notify packet, or send data specifying the server device and network service, to the network controller 240. In this situation, the network controller 240 may then add the network service to the list of available network services 252 stored in the network service cache 250.

The implementation depicted in the example data flow 200 depicts one example set of devices for performing selective network packet processing. In some implementations, the operations performed by the network controller 240 may be included in the network router 230. For example, the network router 230 may include or be in communication with the network service cache 250, and the network router 230 may use the network service cache to store available network services and to determine whether or not an SSDP search packet is to be processed. In some implementations, many network routers may be included in a network, each processing multicast packets in the manner described above. Other example implementations may involve many more user devices, server devices, and network controllers as well.

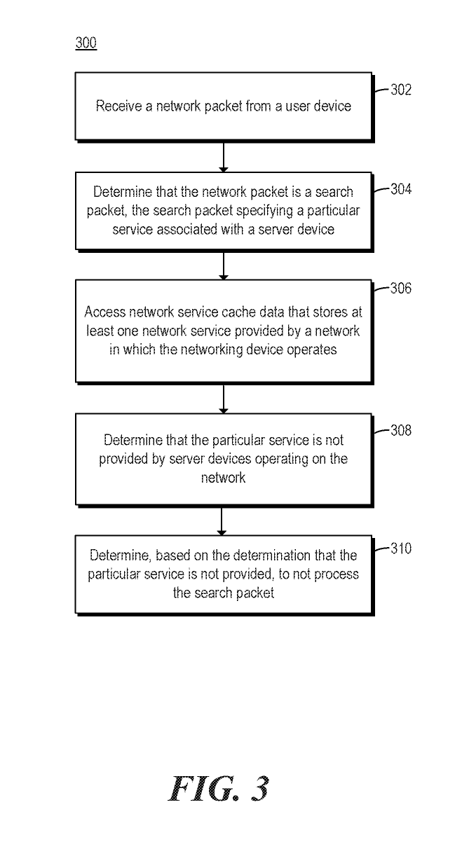

FIG. 3 is a flowchart of an example method 300 for selectively processing network packets. The method 300 may be performed by a networking device, such as the networking device described in FIG. 1 or the network router described with respect to FIG. 2. Other networking devices may also be used to execute method 300. Method 300 may be implemented in the form of executable instructions stored on a machine-readable storage medium, such as the storage medium 130, and/or in the form of electronic circuitry, such as an FPGA or ASIC.

A network packet is received from a user device (302). For example, a mobile phone that is in communication with a network router may send a network packet to the router. E.g., the mobile phone may have one or more applications that cause the mobile phone so send out multicast network packets to network routers to discover network services that may be available on the network.

A determination is made that the network packet is a search packet, the search packet specifying a particular service associated with a server device (304). For example, the network packet sent by the mobile phone may be identified as a search packet by inspecting the packet for data specifying its type. In some implementations, the network packet is inspected in response to identifying the network packet as a multicast packet, e.g., based on a destination address of the packet. The particular service may be any network service associated with a server device that is capable of discovery via multicast, e.g., the particular service may be a multimedia streaming service that an application running on the mobile phone may use to stream audio/video content for output on a separate device in communication with the network.

Network service cache data is accessed, the cache data storing at least one network service provided by a network in which the networking device operates (306). For example, network service cache data may be stored on a storage device of the network router to which the mobile phone sent the network packet, and the cache data may be accessed by the network router. In some implementations, the network service cache date may be received from a network controller.

A determination is made that the particular service is not provided by server devices operating on the network (308). The determination may be made, for example, by determining that the particular service is not included in the network service cache data.

A determination is made, based on the determination that the particular service is not provided, to not process the search packet (310). By way of example, when the network router determines that the requested multimedia streaming service is not available, the network router may halt any further processing of the network packet.

In some implementations, a search packet is received that specifies a network service that is provided by one or more server devices operating on the network. For example, in some situations, the multimedia streaming service that the mobile phone searched for may be a service that is provided by some server devices. In this situation, the network router may process the search packet, e.g., by forwarding it to the address of the server devices that provide the multimedia streaming service. In some implementations, the network router may process the search packet by broadcasting it to server devices, e.g., as with traditional multicast search packet processing.

In some implementations, the method 300 may include receiving a network packet from a server device, and determining that the second network packet is a notify packet. A notify packet is a multicast packet that specifies one or more network services that are offered by the sending server device. In this situation, the method 300 may also include updating the network service cache with data indicating the network service(s) offered by server devices operating on the network. In some implementations, the cache is updated locally on a network device, and in some implementations a network device may notify a network controller, and the network controller may update its network service cache.

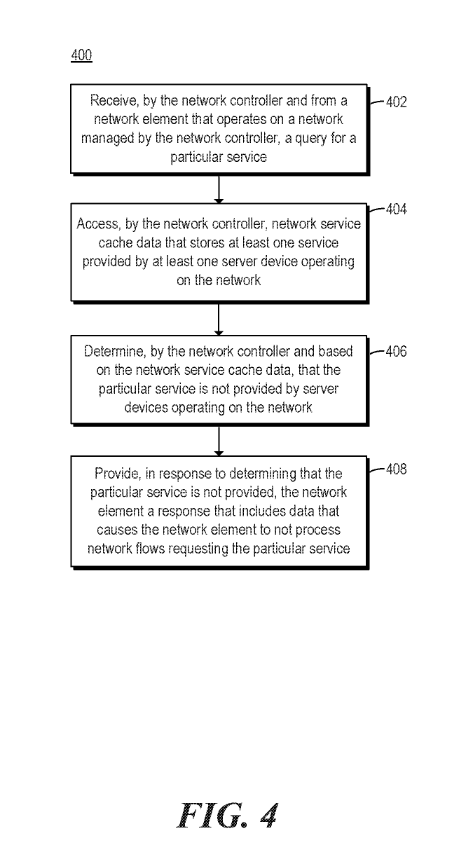

FIG. 4 is a flowchart of an example method 400 for the selective processing of network packets. The method 400 may be performed by a networking device, such as the networking device described with respect to FIG. 1 or the network router described with respect to FIG. 2. Other networking devices may also be used to execute method 400. Method 400 may be implemented in the form of executable instructions stored on a machine-readable storage medium 401, such as the storage medium 130, and/or in the form of electronic circuitry, such as an FPGA or ASIC.

A query for a particular service is received by a network controller and from a network element that operates on a network managed by the network controller (402). For example, a network controller operating in a software defined network may receive a query for a particular network service from a software-defined router operating on the same network. The query may have been sent by the router, for example, in response to the router receiving a multicast request.

Network service cache data is accessed by the network controller, the network service cache data storing at least one service provided by at least one server device operating on the network (404). For example, the network controller may store, in a database, service identifiers and corresponding IP addresses for server devices that provide those services. The database may be populated using notify packets provided by the server devices.

The network controller determines, based on the network service cache data, that the particular service is not provided by server devices operating on the network (406). For example, in situations where the particular service specified by the query is not included in the database of services, the network controller determines that the service is not offered on the network.

In response to determining that the particular service is not provided, the network element is provided with a response that includes data that causes the network element to not process network flows requesting the particular service (408). In some implementations, the data included in the response includes instructions to halt further processing of the search packet. In some implementations the network element uses the data included in the response to halt further processing of the search packet.

Various portions of the methods 300 and 400 may be performed by one or multiple networking devices. For example, one networking device may be responsible for receiving and processing—or not processing—search and notify packets, and another networking device may be responsible for maintaining a database of network services.

The foregoing disclosure describes a number of example implementations for selectively processing network packets. As detailed above, examples provide a mechanism for using a cache of network services to track available network services and to selectively process requests for services that may or may not be available on a network.

We claim:

1. A networking device for selectively processing network packets, the networking device operating in a network of communications devices and comprising:
a hardware processor; and
a machine-readable storage medium storing instructions that, when executed by the hardware processor, cause the hardware processor to:
receive, by the networking device, a network packet from a user device operating on the network;
determine that the network packet is a search packet, the search packet specifying a particular service associated with a server device;
provide a network controller with a query for the particular service;
receive, from the network controller, an indication that the particular service is not provided by server devices operating on the network; and
determine, based on the receipt of the indication, not to process the search packet.

2. The networking device of claim 1, wherein the instructions further cause the hardware processor to:
receive, by the networking device, a second network packet from a second server device operating on the network;
determine that the second network packet is a notify packet, the notify packet specifying that the second server device is offering a second service; and
providing the network controller with data indicating that the second service is being offered by the second server device.

3. The networking device of claim 2, wherein the instructions further cause the hardware processor to:
receive, by the networking device, a third network packet from a second user device operating on the network;
determine that the third network packet is a second search packet, the second search packet specifying the second service;
provide the network controller with a query for the second service;
receive, from the network controller, a second indication that the second service is offered by the second server device; and
determine, based on the receipt of the second indication, to process the second search packet.

4. The networking device of claim 3, wherein the instructions further cause the hardware processor to:
identify routing data included in the second indication; and
process the second search packet by routing the second search packet to the second server device.

5. The networking device of claim 1, wherein the instructions further cause the hardware processor to:
determine, based on a network address associated with the network packet, that the network packet is associated with a multicast message; and
perform packet inspection in response to the determination that the network packet is associated with the multicast message, wherein the determination that the network packet is a search packet is made based on the packet inspection.

6. The networking device of claim 1, wherein the particular service is a network service requested using a multicast message.

7. The networking device of claim 1, wherein the network packet is a Simple Service Discovery Protocol packet.

8. A method for selectively processing network packets, implemented by a hardware processor, the method comprising:
receiving, by a hardware processor of a networking device, a network packet from a user device;
determining, by the hardware processor, that the network packet is a search packet, the search packet specifying a particular service associated with a server device;
accessing, by the hardware processor, network service cache data that stores at least one network service provided by a network in which the networking device operates;
determining, by the hardware processor, that the particular service is not provided by server devices operating on the network; and
determining, based on the determination that the particular service is not provided, to not process the search packet.

9. The method of claim 8, wherein the network service cache data is storage on a data storage device included in the networking device.

10. The method of claim 8, further comprising:
receiving the network service cache data from a network controller operating on the network.

11. The method of claim 8, further comprising:
receiving, by the hardware processor, a second network packet from a second server device operating on the network;
determining, by the hardware processor, that the second network packet is a notify packet, the notify packet specifying that the second server device is offering a second service; and
updating the network service cache with data indicating that the second service is being offered by the second server device.

12. The method of claim 11, further comprising:
receiving, by the hardware processor, a third network packet from a second user device operating on the network;
determining that the third network packet is a second search packet, the second search packet specifying the second service;
identifying, in the network service cache data, the second service, the network service data specifying that the second service is offered by the second server device; and
determining, based on the identification of the second service in the network service cache data, to process the second search packet.

13. The method of claim 12, wherein:
the network service cache data includes routing data for the second server device; and
the second search packet is processed by routing the search packet to the second server device.

14. A non-transitory computer readable medium including instructions that, when executed by a data processor of a network controller, cause the data processor to perform operations for selectively processing network packets, the operations comprising:
receiving, by the network controller and from a network element that operates on a network managed by the network controller, a query for a particular service;
accessing, by the network controller, network service cache data that stores at least one service provided by at least one server device operating on the network;
determining, by the network controller and based on the network service cache data, that the particular service is not provided by server devices operating on the network; and
in response to determining that the particular service is not provided, providing the network element a response that includes data that causes the network element to not process network flows requesting the particular service.

15. The computer readable medium of claim 14, wherein the operations further comprise:
receiving, by the networking controller, a second network packet from a new server device operating on the network;
determining that the second network packet is a notify packet, the notify packet specifying that the new server device is offering a new service; and
updating the network service cache with data indicating that the new service is being offered by the new server device.

16. The computer readable medium of claim 15, wherein the operations further comprise:
receiving, by the network controller, a second query from a second network element operating on the network;
determining, based on the network service cache data, that the second query specifies the new service offered by the new server device; and
providing the second network element with data specifying the new server device.

17. The computer readable medium of claim 16, wherein the operations further comprise:
storing, in the network service cache data, routing data for the new server device; and
providing the routing data for the new server device with the data specifying the new server device.

18. The computer readable medium of claim 14, wherein the particular service is a network service requested using a multicast message.

19. The networking device of claim 1, wherein the network packet is a Simple Service Discovery Protocol packet.
